(19) United States
(12) Patent Application Publication
(10) Pub. No.: US 2021/0263637 A1
(43) Pub. Date: Aug. 26, 2021

(54) METHOD AND DEVICE FOR EXECUTING FUNCTION OF ICON, AND STORAGE MEDIUM

(71) Applicant: BEIJING XIAOMI MOBILE SOFTWARE CO., LTD., Beijing (CN)

(72) Inventors: Yuan ZHANG, Beijing (CN); Guilin ZHONG, Beijing (CN)

(73) Assignee: BEIJING XIAOMI MOBILE SOFTWARE CO., LTD., Beijing (CN)

(21) Appl. No.: 16/924,021

(22) Filed: Jul. 8, 2020

(30) Foreign Application Priority Data
Feb. 20, 2020 (CN) 202010105942.1

(51) Int. Cl. G06F 3/0481; G06K 9/00; G06F 21/32; G06F 21/36

(52) U.S. Cl. CPC G06F 3/04817; G06K 9/00087; G06F 3/0488; G06F 21/36; G06F 21/32

(57) ABSTRACT

Methods, devices, and storage mediums are provided for executing a function associated with an icon. The method includes: displaying the icon in a predetermined display area of a display screen, where a fingerprint detection component is provided at the predetermined display area; detecting an operation on the icon, and acquiring first fingerprint information while the operation is acting on the icon; determining whether the first fingerprint information matches with preset second fingerprint information; and executing the function associated with the icon in response to determining that the first fingerprint information matches with the preset second fingerprint information.

### CROSS-REFERENCE TO RELATED APPLICATIONS

This application is based on and claims priority to Chinese patent application No. 202010105942.1 filed on Feb. 20, 2020, the entirety of which is hereby incorporated by reference for all purposes.

### TECHNICAL FIELD

The disclosure relates to the technical field of terminals, and particularly to a method and device for executing a function associated with an icon.

### BACKGROUND

In order to improve information security, users usually encrypt some information, applications, etc. For example, some applications of a terminal are encrypted by means of application locks, etc. When accessing encrypted information or applications, icons of the encrypted information or applications need to be touched at first, then identity verification is performed through an identity verification interface triggered by the touch operation. The encrypted information or applications are started when the identity verification is passed. Identity verification may be realized by: a password, a fingerprint, etc. The entire accessing process is complicated.

### SUMMARY

In embodiments of the disclosure, provided are a method and device for executing a function associated with an icon.

According to a first aspect of the disclosure, a method for executing a function associated with an icon is provided. The method includes: displaying the icon in a predetermined display area of a display screen, wherein a fingerprint detection component is provided at the predetermined display area; detecting an operation on the icon, and acquiring first fingerprint information while the operation is acting on the icon; determining whether the first fingerprint information matches with preset second fingerprint information; and executing the function associated with the icon in response to determining that the first fingerprint information matches with the preset second fingerprint information.

According to a second aspect of the disclosure, a device for executing a function associated with an icon is provided. The device includes a first display module, an acquisition module, a determination module and an execution module. The first display module is configured to display the icon in a predetermined display area of a display screen, wherein a fingerprint detector is provided at the predetermined display area; the acquisition module is configured to detect an operation on the icon, and acquire first fingerprint information while the operation is acting on the icon; the determination module is configured to determine whether the first fingerprint information matches with preset second fingerprint information; and the execution module is configured to execute the function associated with the icon in response to determining that the first fingerprint information matches with the preset second fingerprint information.

According to a third aspect of the disclosure, a device for executing a function associated with an icon is provided. The device includes a processor, a display screen electronically coupled with the processor, and a memory with a processor-executable program stored thereon. The processor, when running the processor-executable program, is configured to: instruct the display screen to display an icon in a predetermined display area of the display screen, wherein a fingerprint detection component is provided at the predetermined display area; detect an operation on the icon, and acquiring first fingerprint information while the operation is acting on the icon; determine whether the first fingerprint information matches with preset second fingerprint information; and execute a function associated with the icon in response to determining that the first fingerprint information matches with the preset second fingerprint information.

It should be understood that the above general description and the following detailed description are merely exemplary and explanatory, but do not limit the embodiments of the disclosure.

### BRIEF DESCRIPTION OF THE DRAWINGS

The accompanying drawings, which are incorporated in and constitute a part of this specification, illustrate embodiments consistent with the disclosure and, together with the specification, serve to explain the principles of the embodiments of the disclosure.

FIG. 1 illustrates a schematic flow diagram of a method for executing a function associated with an icon according to an example.

FIG. 2 illustrates a schematic diagram of a position of an icon display area according to an example.

FIG. 3 illustrates another schematic diagram of the position of the icon display area according to an example.

FIG. 4A illustrates a further schematic diagram of the position of the icon display area according to an example.

FIG. 4B illustrates a further schematic diagram of the position of the icon display area according to an example.

FIG. 5 illustrates a schematic flow diagram of a method for executing a function associated with an icon in a terminal according to an example.

FIG. 6 illustrates a schematic structural diagram of composition of a device for executing a function associated with an icon according to an example.

FIG. 7 illustrates another schematic structural diagram of the composition of the device for executing a function associated with an icon according to an example.

FIG. 8 illustrates a further schematic structural diagram of the composition of the device for executing a function associated with an icon according to an example.

FIG. 9 illustrates a further schematic structural diagram of the composition of the device for executing a function associated with an icon according to an example.

FIG. 10 illustrates a further schematic structural diagram of the composition of the device for executing a function associated with an icon according to an example.

FIG. 11 illustrates a block diagram of a device for executing a function associated with an icon according to an example.

### DETAILED DESCRIPTION

Exemplary embodiments will be described in detail herein, examples of which are illustrated in the accompanying drawings. When the following description refers to the accompanying drawings, the same numbers in different drawings represent the same or similar elements unless otherwise indicated. The implementations set forth in the following description of exemplary embodiments do not represent all implementations consistent with the embodiments of the disclosure. Instead, they are merely examples of devices and methods consistent with aspects related to the embodiments of the disclosure as recited in the appended claims.

The terms used in the embodiments of the disclosure are for the purpose of describing particular embodiments only, and are not intended to limit the embodiments of the disclosure. “A/an”, “the” and “this” in a singular form in the embodiments of the disclosure and the appended claims are also intended to include a plural form, unless other meanings are clearly denoted throughout the disclosure. It should also be understood that the term “and/or” as used herein refers to and includes any or all possible combinations of one or more associated listed items.

It is to be understood that although the terms first, second, third, etc. may be used in the embodiments of the disclosure to describe various information, such information should not be limited to these terms. These terms are used only to distinguish information of the same type from each other. For example, without departing from the scope of the embodiments of the disclosure, first information may also be called second information and, similarly, second information may also be called first information. Depending on the context, the word “if” as used herein may be explained as “when . . . ”, “while” or “in response to determining”.

The execution subjects involved in the embodiments of the disclosure include, but not limited to, a terminal with an under-screen fingerprint recognition function, and the like.

The application scenes of the embodiments of the disclosure include, but are not limited to, application locks. In the related art, unlocking steps include: step A: an application icon to be opened is clicked; step B: an identity verification information input interface, such as a fingerprint input interface and a password input interface, are popped up; and step C: a fingerprint is entered for unlocking, and the application is entered. The steps are relatively complicated.

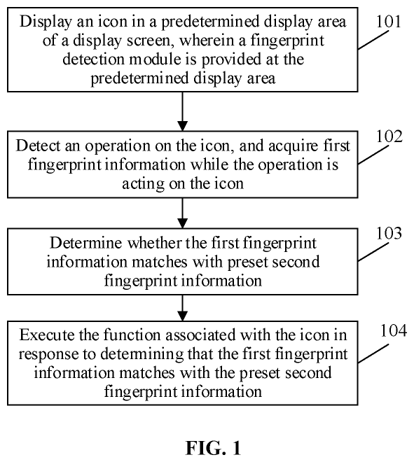

As illustrated in FIG. 1, in the example, provided is a method for executing a function associated with an icon. The method for executing a function associated with an icon may be applied to a terminal and includes steps 101, 102, 103 and 104.

In step 101, an icon is displayed in a predetermined display area of a display screen. A fingerprint detector is provided at the predetermined display area.

In step 102, an operation on the icon is detected, and first fingerprint information is acquired while the operation is acting on the icon.

In step 103, whether the first fingerprint information matches with preset second fingerprint information is determined.

In step 104, the function associated with the icon is executed in response to determining that the first fingerprint information matches with the preset second fingerprint information.

Here, the terminal may be such as a mobile phone with an under-screen fingerprint recognition function. The under-screen fingerprint recognition technology refer to a technology that fingerprint recognition is completed by a fingerprint detector under a screen when a finger is placed on the screen. The fingerprint detector may realize fingerprint recognition on the display screen in a full-screen manner or locally by using ultrasonic waves, infrared light, etc. penetrating through the screen.

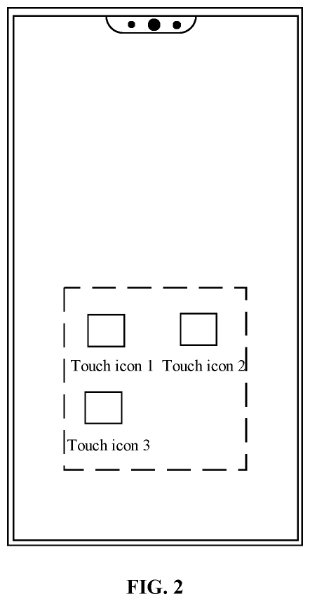

The predetermined display area may be the entire display screen or a part of the display screen. As in a display screen of a terminal illustrated in FIG. 2, an icon may be displayed in a fingerprint recognition range of the fingerprint detector indicated by dotted lines. Here, the icon may be an application icon of an application or a file icon of a file. The fingerprint recognition range may include one or more icons. When a full-screen fingerprint recognition technology is used in the fingerprint detector, the method in the example of the disclosure may be applied to the entire display screen. When the fingerprint detector can only realize fingerprint recognition on the display screen locally, the method in the example of the disclosure may be applied to the area where the fingerprint detector may perform fingerprint recognition.

Here, the operation may be a touch operation or a hovering operation. The touch operation on the display screen or the hovering operation over the display screen may be sensed through a capacitive sensing function. The fingerprint detector may sense a fingerprint touching the display screen or hovering at a certain distance from the display screen.

When a user operates the icon within the fingerprint recognition range, the fingerprint detector acquires the first fingerprint information of the operation. If the first fingerprint information matches with the second fingerprint information preset for the icon, the function associated with the icon is started. The function associated with the icon may be a function that can be started only after identity verification is passed. For example, the function is executed by unlocking a lock of the function. The second fingerprint information may be preset identity verification information of the function associated with the icon.

The matching of the first fingerprint information with the second fingerprint information may include the situations where the first fingerprint information is identical to the second fingerprint information, the degree of similarity between the first fingerprint information and the second fingerprint information is greater than a preset similarity threshold, or the like. For example, the similarity threshold may be set to be 95%. If the degree of similarity between the first fingerprint information and the second fingerprint information is greater than 95%, the first fingerprint information is considered to be matched with the second fingerprint information. Otherwise, the first fingerprint information is considered to be not matched with the second fingerprint information. The similarity comparison between the first fingerprint information and the second fingerprint information may be a similarity comparison of feature points of fingerprints.

In this way, when the user operates the icon, identity verification for the icon, and execution of the function associated with the icon may be completed at the same time. The operation of the icon, the input of the identity verification information, the execution of the function associated with the icon, and the like may be completed in one operation, thereby simplifying the operation and improving the operation efficiency.

In one or more embodiments, the step 104 may include that: in response to determining that the first fingerprint information matches with the preset second fingerprint information, user information which has pre-established a mapping relationship with the second fingerprint information is retrieved; and the function associated with the icon is executed based on the user information.

User information usually needs to be input for executing the function associated with the icon. The user information may be used for user login or user information input. Here, the user information has pre-established a mapping relationship with the second fingerprint information. If the first fingerprint information matches with the second fingerprint information, the user information may be used for login or input.

In one or more embodiments, the step that the function associated with the icon is executed based on the user information includes at least one of: an application corresponding to the icon is logged into with the user information; or the function corresponding to the icon is unlocked with the user information.

The user information may be user login information. Here, the user login information has pre-established a mapping relationship with the second fingerprint information. If the first fingerprint information matches with the second fingerprint information, the function associated with the icon may be executed, and the application may be logged into with the user information. After the user logs into the application, different access rights or different specific functions may be implemented for the user having logged in.

Exemplarily, the icon is an application icon of an application. The application is preset with second fingerprint information, the second fingerprint information has pre-established a mapping relationship with user information. The user information may be verification information or authentication information for login of a specific user of the application. The verification information or authentication information for user login may include a user name, password information, and the like. When the application icon is operated, the fingerprint detector acquires fingerprint information during the operation. The acquired fingerprint information is compared with the second fingerprint information. If the acquired fingerprint information matches with the second fingerprint information, the application is logged into with the user information having pre-established the mapping relationship with the second fingerprint information.

The user information may also be unlocking information of a lock of the function corresponding to the icon. Here, the unlocking information has pre-established a mapping relationship with the second fingerprint information. If the first fingerprint information matches with the second fingerprint information, the lock of the function corresponding to the icon may be unlocked.

In one or more embodiments, the step 102 may include that: a duration of the operation on the icon is detected, when the operation on the icon has been detected; and the first fingerprint information is acquired by the fingerprint detector, while the operation continues to act on the icon after the duration of the operation on the icon reaches a first duration.

Here, the first fingerprint information may be acquired only for a specific operation. The specific operation may be an operation of which a continuous touch duration reaches the first duration, etc. Here, the first duration may be preset to be 1 second, 2 seconds, etc. In one example, the first duration is 1 second and when the touch duration of a user's finger on the icon reaches 1 second, the fingerprint detector starts to acquire the first fingerprint information and performs fingerprint matching. In this way, for different touch operations, different operation responses may be given, thus improving flexibility.

In one or more embodiments, the method further includes: predetermined information is output in response to determining that the duration of the operation on the icon ends before reaching the first duration. The predetermined information includes at least one of the following: prompt information for prompting a user to input information for executing the function associated with the icon; or a verification input interface for inputting verification information for executing the function associated with the icon.

For an icon for which identity verification steps such as fingerprint recognition must be carried out before executing the set function, if the touch duration ends before reaching the first duration, an interaction interface may be displayed to prompt the user to perform identity verification.

The prompt information may be provided in a form of a pop-up window. When the touch duration ends without reaching the first duration, the prompt information is popped up. The prompt information may be configured to prompt a touch duration required for executing the function associated with the icon, prompt the user to select a user verification mode, or the like.

The interaction interface may also be a verification input interface. The verification input interface may be a fingerprint input interface, a user name and password input interface, or the like. The user may input the verification information through the verification input interface to execute the function associated with the icon.

In one or more embodiments, the step that the first fingerprint information is acquired by the fingerprint detector, while the operation continues to act on the icon after the duration of the touch operation on the icon reaches a first duration includes that: when an operating system of an electronic device detects that the duration of the touch operation on the icon reaches the first duration, a fingerprint detection program of the started fingerprint detector is used to acquire the first fingerprint information while the operation continues to act on the icon.

Here, the touch operation of the user may be sensed by a touch sensor in the electronic device, and the touch duration may be detected by the operating system. The electronic device may be a terminal device such as a mobile phone. The operating system may be an operating system in a mobile phone. The operating system may detect the touch duration through an additional program.

When the touch duration reaches the first duration, the operating system may use the fingerprint detection program to drive the fingerprint detector to acquire the first fingerprint information.

In some embodiments, the fingerprint detector may be a always-on module, that is, the fingerprint detector is started while the terminal device is started. As such, the fingerprint detector may be used to acquire a fingerprint during the touch process once a touch operation is detected.

In some other embodiments, in order to reduce the power consumption of the fingerprint detector, the fingerprint detector is started only after an operation is detected. As such, the first duration may be determined according to the duration required for the fingerprint detector to switch from an off state to an on state.

In some embodiments, when it is detected that the screen is lightened up, the fingerprint detector is started in advance, to increase the response speed during the fingerprint recognition.

In one or more embodiments, the method further includes that: a fingerprint information input interface is presented in response to determining that the first fingerprint information is not matched with the second fingerprint information.

If the first fingerprint information is not matched with the second fingerprint information, the terminal may display a prompt interface. The prompt interface may include such as identity verification failure prompt information and/or an identity verification information input interface. The identity verification information input interface may be used for the user to input a fingerprint or password again.

In one or more embodiments, the step that the icon is displayed in the predetermined display area of the display screen includes that: the icon is displayed in a predetermined full-screen display area of the display screen, wherein the fingerprint detector is provided at the icon within the full-screen display area; or a human-machine interaction signal is acquired from a user, and the icon is displayed in a local area of the display screen based on the human-machine interaction signal, wherein the fingerprint detector is provided at the icon at least in the local area of the display screen.

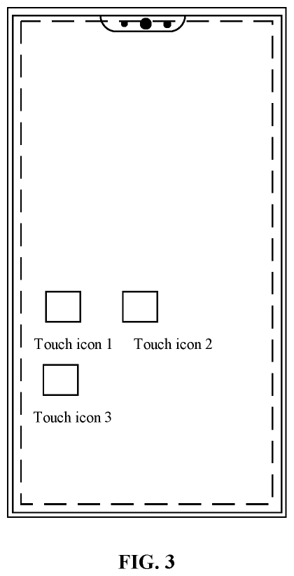

Here, as illustrated in FIG. 3, the fingerprint detector may detect a fingerprint for the full-screen display area of the display screen indicated by the dotted lines. Thus, fingerprint detection may be realized for each of icons in the full-screen display area. Alternatively, the fingerprint detector may also be arranged only for an icon in the full-screen display area, for example, one fingerprint detector is provided for one icon under the display screen. Thus, fingerprint detection may be realized for icons on the full screen.

In some other embodiments, as illustrated in FIG. 2, the human-machine interaction signal may be an instruction of the user specifying a local area. The user may specify a local area for fingerprint detection. The fingerprint detector only detects a fingerprint for the operation on the icon in the specified local area, and does not perform fingerprint detection beyond the specified local area. The workload of the fingerprint detector can be reduced, and electric energy can be saved.

In one or more embodiments, when the display screen is in a portrait-screen state, the predetermined display area includes a bottom half of the display screen. When the display screen is in a landscape-screen state, the predetermined display area includes a right half of the display screen.

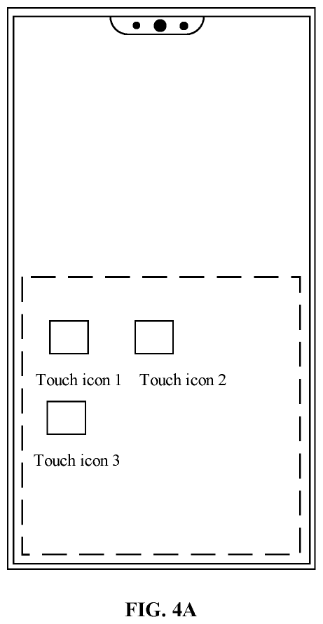

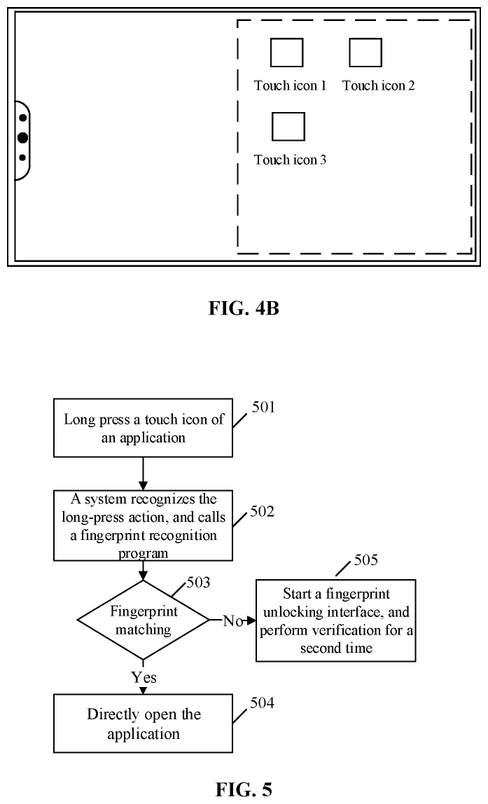

Here, for different operation habits, the display area may be provided at a part of the display screen close to the user's holding hand. Exemplarily, with a right-handed operation habit as an example, as illustrated by the dotted box in FIG. 4A, in the portrait-screen state, the display area is provided at the bottom half of the display screen. As illustrated by the dotted box in FIG. 4B, in the landscape-screen state, the display area is provided at the right half of the display screen. Therefore, the user may conveniently perform the touch operation.

In one or more embodiments, the step that the function associated with the icon is executed includes at least one of the following: when the icon is an application icon of an application, the application is started; when the icon is a file icon of a file, the file is opened; and when the icon is a control icon of a payment control, a payment operation is executed.

The application may have such as an application lock that requires access identity verification. For example, the application may be an application with high security requirements. Before such an application is started, identity verification is required, and the application will be started only if the identity verification is passed. Here, by means of the method according to the embodiments of the disclosure, when a user operates an icon of an application, the fingerprint detector may acquire the first fingerprint information of the operation and compare the preset second fingerprint information with the first fingerprint information. If the second fingerprint information matches with the first fingerprint information, the user is deemed to have an operation right, and the application is started. By means the method according to the embodiments of the disclosure, the steps of executing an application having such as an application lock that requires identity verification requirement may be simplified, and the efficiency of starting the encrypted application may be improved.

The file may be encrypted by such as a fingerprint. Before such a file is opened, identity verification is required, and the file can be opened only if the identity verification is passed. Here, by means of the method according to the embodiments of the disclosure, when a user operates a file icon of a file, the fingerprint detector may acquire first fingerprint information of the operation and compare the preset second fingerprint information with the first fingerprint information. If the second fingerprint information matches with the first fingerprint information, the user is deemed to have an access right, and the file is opened. By means the method according to the embodiments of the disclosure, the steps of accessing an encrypted file may be simplified, and the efficiency of opening the encrypted file may be improved.

The payment control may be a control for network payment. The payment control usually has high security requirements. Usually, when the payment control is executed, bar code information for payment is displayed, or payment is implemented directly. Here, by means the method according to the embodiments of the disclosure, when a user operates a control icon of an application, the fingerprint detector may acquire first fingerprint information of the operation and compare the preset second fingerprint information with the first fingerprint information. If the second fingerprint information matches with the first fingerprint information, the user is deemed to have an operation right, and the payment control is started. By means of the method according to the embodiments of the disclosure, the steps of executing the payment control may be simplified.

In one or more embodiments, the step 102 may include: a touch operation or a hovering operation on the icon is detected.

Here, the operation may be a touch operation or a hovering operation. The touch operation or the hovering operation may be sensed through a capacitive sensing function by the display screen. A finger touching the icon on display screen or hovering at a certain distance above the icon on the display screen by means of such as capacitive sensing by the display screen.

The fingerprint detector may detect, by means of such as capacitive sensing or infrared scanning, a fingerprint of the finger touching the icon on the display screen or hovering at a certain distance above the icon on the display screen.

In one or more embodiments, the step 102 may include: a touch duration of the touch operation on the icon is detected, or a hovering duration of the hovering operation on the icon is detected.

The step that the function associated with the icon is executed includes: the function associated with the icon is executed based on the touch duration or the hovering duration.

Different functions may be associated with different durations of operations on icons.

Exemplarily, for a short-time touch operation, such as a touch operation with a touch duration shorter than a preset duration threshold, an application corresponding to an icon may be started, or a file corresponding to an icon may be opened, or the like. The fingerprint detector may detect a fingerprint within the touch duration. When the fingerprint matches, the application is started, or the file is opened. Otherwise, the application is not started, or the file is not opened. The preset duration threshold may be adjusted by the user. For example, the user may adjust the preset duration threshold to be any value between 0.3 second and 5 seconds. In one example, the default value for the preset duration threshold is set to 1 second.

For a long-time touch operation, such as a touch operation with a touch duration longer than preset duration threshold, an operation dialog box of an application corresponding to an icon may be displayed, or an operation dialog box of a file corresponding to an icon may be opened, or the like. The fingerprint detector may detect a fingerprint within the touch duration. When the fingerprint matches, the operation dialog box is displayed. Otherwise, the operation dialog box is not displayed.

For a short-time hovering operation, such as a hovering operation with a hovering duration shorter than preset duration threshold, an application corresponding to an icon may be started, or a file corresponding to an icon may be opened, or the like. The fingerprint detector may detect a fingerprint within the hovering duration. When the fingerprint matches, the application is started, or the file is opened. Otherwise, the application is not started, or the file is not opened.

For a long-time hovering operation, such as a hovering operation with a hovering duration longer than preset duration threshold, an operation dialog box of an application corresponding to an icon may be displayed, or an operation dialog box of a file corresponding to an icon may be opened, or the like. The fingerprint detector may detect a fingerprint within the hovering duration. When the fingerprint matches, the operation dialog box is displayed. Otherwise, the operation dialog box is not displayed.

A particular example is provided below in combination with any of the above embodiments:

1. The particular steps for starting an application with an application lock in a terminal using the method according to the embodiments of the disclosure are illustrated in FIG. 5 and include the following steps 501, 502, 503, 504 and 505.

In step 501, an application icon of the application is touched. The application icon is within a fingerprint recognition range of a display screen.

In step 502, if a system recognizes that the touch operation is a preset long-press action, a fingerprint of the touch operation is acquired, and fingerprint matching is performed.

In step 503, if the fingerprint matching is successful, step 504 is executed, otherwise, step 505 is executed.

In step 504, the application is unlocked and started.

In step 505, a dialog interface is popped up to prompt that the fingerprint is not matched, and a secondary fingerprint input interface, a password input interface or the like are provided, so that a user performs unlocking again.

2. The method according to the embodiments of the disclosure may also be applied to applications with a user login function.

A mobile phone has an intelligent function of password management. After fingerprint authentication, user login information may be automatically filled in for different records.

When the application icon of the application is clicked by means of a short-time pressing and the like, the application is in a not-logged-in state, and a login dialog interface and the like may be popped up. When the finger with a recorded fingerprint long presses the application icon of the application, the fingerprint recognition function may be used. After successful authentication, user login information may be automatically filled in, and the application is entered in a logged-in state. In a similar way, the operation is also applicable to various types of bank software needing fingerprint verification before opening user information.

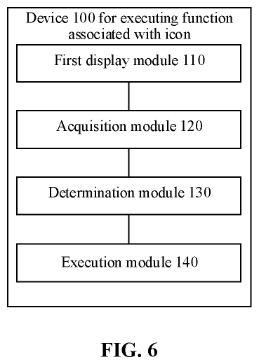

In embodiments of the disclosure, also provided is a device for executing a function associated with an icon. FIG. 6 illustrates a schematic structural diagram of composition of a device for executing a function associated with an icon 100 provided In one or more embodiments of the disclosure. As illustrated in FIG. 6, the device 100 includes a first display module 110, an acquisition module 120, a determination module 130 and an execution module 140.

The first display module 110 is configured to display the icon in a predetermined display area of a display screen. A fingerprint detector is provided at the predetermined display area.

The acquisition module 120 is configured to detect an operation on the icon, and acquire first fingerprint information while the operation is acting on the icon.

The determination module 130 is configured to determine whether the first fingerprint information matches with preset second fingerprint information.

The execution module 140 is configured to execute the function associated with the icon in response to determining that the first fingerprint information matches with the preset second fingerprint information.

In one or more embodiments, as illustrated in FIG. 7, the execution module 140 includes a first execution sub-module 141.

The first execution sub-module 141 is configured to: in response to determining that the first fingerprint information matches with the preset second fingerprint information, retrieve user information which has pre-established a mapping relationship with the second fingerprint information; and execute, based on the user information, the function associated with the icon.

In one or more embodiments, as illustrated in FIG. 7, the first execution sub-module 141 includes at least one of: a first execution unit 1411 or a second execution unit 1412.

The first execution unit 1411 configured to log, with the user information, into an application corresponding to the icon.

The second execution unit 1412 configured to unlock, with the user information, the application corresponding to the icon.

In one or more embodiments, as illustrated in FIG. 7, the acquisition module 120 includes: a timing sub-module 121 and a first acquisition sub-module.

The timing sub-module 121 is configured to detect a duration of the operation on the icon, when the operation on the icon is detected.

The first collecting sub-module 122 is configured to acquire, by the fingerprint detector, the first fingerprint information, while the operation continues to act on the icon after the duration of the operation on the icon reaches a first duration.

In one or more embodiments, as illustrated in FIG. 7, the device 100 further includes a second display module 150.

The second display module 150 is configured to output predetermined information in response to determining that the duration of the operation on the icon ends before reaching the first duration. The predetermined information includes at least one of the following: prompt information for prompting a user to input information for executing the function associated with the icon; or a verification input interface for inputting verification information for executing the function associated with the icon.

In one or more embodiments, as shown in FIG. 7, the device 100 further includes a third display module 160.

The third display module 160 is configured to present a fingerprint information input interface in response to determining that the first fingerprint information is not matched with the second fingerprint information.

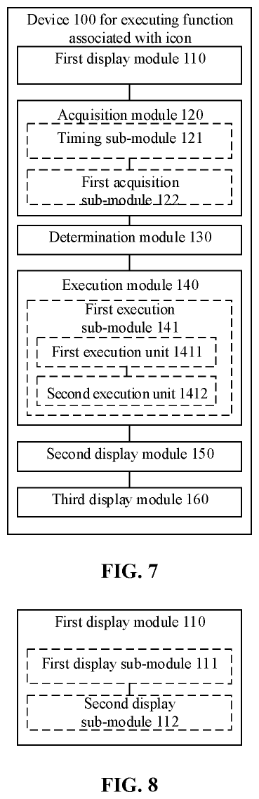

In one or more embodiments, as illustrated in FIG. 8, the first display module 110 includes one of: a first display sub-module 111 or a second display sub-module 112.

The first display sub-module 111 is configured to display the icon in a predetermined full-screen display area of the display screen. The fingerprint detector is provided at the icon within the full-screen display area range.

The second display sub-module 112 is configured to acquire a human-machine interaction signal from a user, and display the icon in a local area of the display screen based on the human-machine interaction signal. The fingerprint detector is provided at the icon at least in the local area of the display screen.

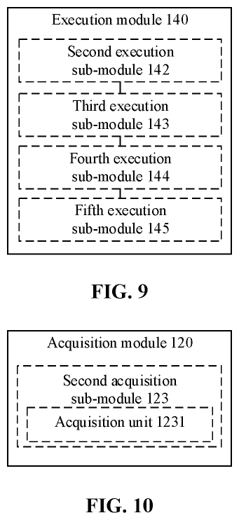

In one or more embodiments, as illustrated in FIG. 9, the execution module 140 includes at least one of the following: a second execution sub-module 142, a third execution sub-module 143, or a fourth execution sub-module 144.

The second execution sub-module 142 is configured to: when the icon is an application icon of an application, start the application.

The third execution sub-module 143 is configured to: when the icon is a file icon of a file, open the file.

The fourth execution sub-module 144 is configured to: when the icon is a control icon of a payment control, execute a payment operation.

In one or more embodiments, as illustrated in FIG. 10, the acquisition module 120 includes a second acquisition sub-module 123.

The second acquisition sub-module 123 is configured to detect a touch operation or a hovering operation on the icon.

In one or more embodiments, the second acquisition sub-module 123 includes an acquisition unit 1231. The acquisition unit 1231 is configured to detect a touch duration of the touch operation on the icon, or detect a hovering duration of the hovering operation on the icon.

The execution module 140 includes a fifth execution sub-module 145. The fifth execution sub-module 145 is configured to execute, based on the touch duration or the hovering duration, the function associated with the icon.

In an example, the first display module 110, the acquisition module 120, the determination module 130, the execution module 140, the second display module 150, the third display module 160 and the like may be implemented by one or more central processing units (CPUs), graphics processing units (GPUs), baseband processors, application specific integrated circuits (ASICs), digital signal processors (DSPs), programmable logic devices (PLDs), complex programmable logic devices (CPLDs), field-programmable gate arrays (FPGAs), general-purpose processors, controllers, micro controller units (MCUs), microprocessors, or other electronic components, and may also be implemented in combination with one or more radio frequency (RF) antennas to execute the above method.

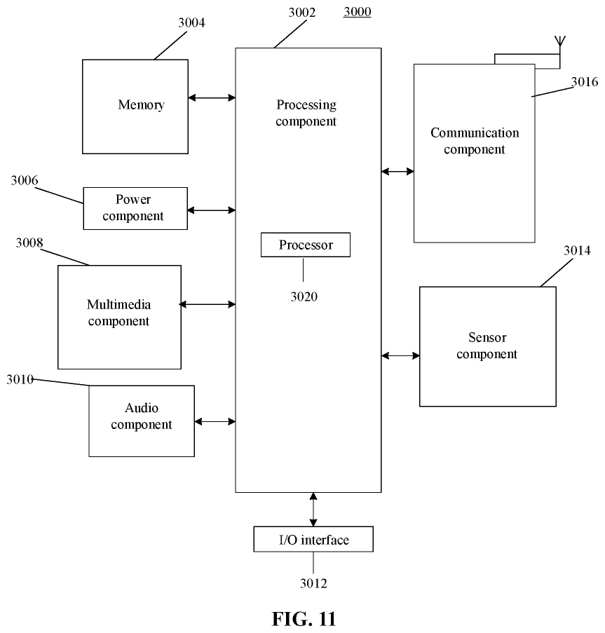

FIG. 11 illustrates a block diagram of a device 3000 for executing a function associated with an icon according to an example.

For example, the device 3000 may be a mobile phone, a computer, a digital broadcasting terminal, a messaging device, a game console, a tablet device, medical equipment, fitness equipment, a personal digital assistant, and the like.

Referring to FIG. 11, the device 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls overall operation of the device 3000, such as operations related to display, telephone calls, data communication, camera operation, and recording operation. The processing component 3002 may include one or more processors 3020 to execute instructions to complete all or some of the steps of the method described above. In addition, the processing component 3002 may include one or more modules to facilitate the interaction between the processing component 3002 and other components. For example, the processing component 3002 may include a multimedia module to facilitate the interaction between the multimedia component 3008 and the processing component 3002.

The memory 3004 is configured to store various types of data to support the operation of the device 3000. Examples of such data include instructions of any application program or method for operating on the device 3000, contact data, phone book data, messages, pictures, videos, and the like. The memory 3004 may be implemented by any type of volatile or non-volatile storage devices or a combination thereof, such as static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 3006 provides power for various components of the device 3000. The power component 3006 may include a power management system, one or more power supplies, and other components associated with generating, managing, and distributing power for the device 3000.

The multimedia component 3008 includes a screen providing an output interface between the device 3000 and a user. In some embodiments, the screen may include a liquid crystal display (LCD) and a touch panel (TP). If the screen includes a TP, the screen may be implemented as a touch screen to receive an input signal from the user. The TP includes one or more touch sensors to sense touch, slide, and gestures on the TP. The touch sensors may not only sense a boundary of a touch or slide action, but also detect a duration and pressure associated with the touch or slide action. In some embodiments, the multimedia component 3008 includes a front camera and/or a rear camera. The front camera and the rear camera may receive external multimedia data while the device 3000 is in an operation mode, such as a photographing mode or a video mode. Each front camera and each rear camera may be fixed optical lens systems or may have focal lengths and optical zoom capabilities.

The audio component 3010 is configured to output and/or input audio signals. For example, the audio component 3010 includes a microphone (MIC), and the microphone is configured to receive external audio signals when the device 3000 is in an operation mode, such as a calling mode, a recording mode, and a voice recognition mode. The received audio signals may be further stored in the memory 3004 or transmitted via the communication component 3016. In some embodiments, the audio component 3010 may further include a speaker to output audio signals.

The I/O interface 3012 provides an interface between the processing component 3002 and a peripheral interface module. The peripheral interface module may be a keyboard, a click wheel, a button, and the like. These buttons may include, but not limited to: a home button, a volume button, a start button, and a lock button.

The sensor component 3014 includes one or more sensors configured to provide various aspects of state assessment for the device 3000. For example, the sensor component 3014 may detect an on/off status of the device 3000, and relative positioning of components. For example, the component is a display and a keypad of the device 3000. The sensor component 3014 may also detect a change in position of the device 3000 or a component of the device 3000, presence or absence of user contact with the device 3000, an orientation or an acceleration/deceleration of the device 3000, and a change in temperature of the device 3000. The sensor component 3014 may include a proximity sensor configured to detect the presence of objects nearby without any physical contact. The sensor component 3014 may also include light sensors, such as complementary metal oxide semiconductor (CMOS or charge coupled device (CCD) image sensors, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communications between the device 3000 and other devices. The device 3000 may access a wireless network based on a communication standard, such as Wi-Fi, 2G or 3G, or a combination thereof. In an example, the communication component 3016 receives broadcast signals or broadcast related information from an external broadcast management system via a broadcast channel. In an example, the communication component 3016 further includes a near field communication (NFC) module to facilitate short-range communications. For example, the NFC module may be implemented based on a radio frequency identification (RFID) technology, an infrared data association (IrDA), an ultra-wide band (UWB) technology, a bluetooth (BT) technology and other technologies.

In an example, the device 3000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above method.

In an example, a non-transitory computer-readable storage medium including instructions, such as a memory 3004 including instructions, is further provided. The instructions may be executed by a processor 3020 of the device 3000 to complete the foregoing method. For example, the non-transitory computer readable storage medium may be a read-only memory (ROM), a random access memory (RAM), a compact disc read-only memory (CD-ROM), a magnetic tape, a floppy disc, an optical data storage device, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the apparatus or system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

Other implementations of the embodiments of the disclosure will be apparent to those skilled in the art from consideration of the specification and practice of the disclosure here. The disclosure is intended to cover any variation, usage, or adaptation of the embodiments of the disclosure following the general principles thereof and including such departures from the embodiments of the disclosure as come within known or customary practice in the art. It is intended that the specification and examples are considered as exemplary only, with a true scope and spirit of the embodiments of the disclosure being indicated by the following claims.

It will be appreciated that the embodiments of the disclosure are not limited to the exact construction that has been described above and illustrated in the accompanying drawings, and that various modifications and changes can be made without departing from the scope thereof. It is intended that the scope of the embodiments of the disclosure is only limited by the appended claims.

1. A method, comprising:
displaying, by a terminal comprising a display screen including a predetermined display area, an icon in the predetermined display area of the display screen, wherein a fingerprint detection component is provided at the predetermined display area;
detecting, by the terminal, an operation on the icon, and acquiring first fingerprint information while the operation is acting on the icon;
determining, by the terminal, whether the first fingerprint information matches with preset second fingerprint information; and
executing, by the terminal based on a duration of the operation on the icon, a function associated with the icon in response to determining that the first fingerprint information matches with the preset second fingerprint information, wherein different durations of the operation on the icon correspond to different functions associated with the icon,
wherein executing the function associated with the icon in response to determining that the first fingerprint information matches with the preset second fingerprint information comprises:
in response to determining that the first fingerprint information matches with the preset second fingerprint information, retrieving user information which has pre-established a mapping relationship with the second fingerprint information; and
logging, with the user information, into an application corresponding to the icon or unlocking, with the user information, the function corresponding to the icon.

2.-3. (canceled)

4. The method of claim 1, wherein
detecting the operation on the icon comprises:
detecting a duration of the operation on the icon, when the operation on the icon has been detected; and
acquiring the first fingerprint information while the operation is acting on the icon comprises:
acquiring, by the fingerprint detection component, the first fingerprint information, while the operation continues to act on the icon after the duration of the operation on the icon reaches a first duration.

5. The method of claim 4, further comprising:
outputting predetermined information in response to determining that the duration of the operation on the icon ends before reaching the first duration, wherein the predetermined information comprises at least one of the following:
prompt information for prompting a user to input information for executing the function associated with the icon; or
a verification input interface for inputting verification information for executing the function associated with the icon.

6. The method of claim 1, further comprising:
presenting a fingerprint information input interface in response to determining that the first fingerprint information is not matched with the second fingerprint information.

7. The method of claim 1, wherein displaying the icon in the predetermined display area of the display screen comprises:
displaying the icon in a predetermined full-screen display area of the display screen, wherein the fingerprint detection component is provided at the icon within the full-screen display area; or
acquiring a human-machine interaction signal from a user, and displaying the icon in a local area of the display screen based on the human-machine interaction signal, wherein the fingerprint detection component is provided at the icon at least in the local area of the display screen.

8. The method of claim 1, wherein executing the function associated with the icon comprises at least one of the following:
when the icon is an application icon of an application, starting the application;
when the icon is a file icon of a file, opening the file; or
when the icon is a control icon of a payment control, executing a payment operation.

9. The method of claim 1, wherein detecting the operation on the icon comprises:
detecting a touch operation or a hovering operation on the icon.

10. (canceled)

11. A device, comprising:
a processor,
a display screen electronically coupled with the processor, and
a memory with a processor-executable program stored thereon, wherein the processor, when running the processor-executable program, is configured to:
instruct the display screen to display an icon in a predetermined display area of the display screen, wherein a fingerprint detection component is provided at the predetermined display area;
detect an operation on the icon, and acquiring first fingerprint information while the operation is acting on the icon;
determine whether the first fingerprint information matches with preset second fingerprint information; and
execute, based on a duration of the operation on the icon, a function associated with the icon in response to determining that the first fingerprint information matches with the preset second fingerprint information, wherein different durations of the operation on the icon correspond to different functions associated with the icon,
wherein executing the function associated with the icon in response to determining that the first fingerprint information matches with the preset second fingerprint information comprises:
in response to determining that the first fingerprint information matches with the preset second fingerprint information, retrieving user information which has pre-established a mapping relationship with the second fingerprint information; and
logging, with the user information, into an application corresponding to the icon or unlocking, with the user information, the function corresponding to the icon.

12.-13. (canceled)

14. The device of claim 11, wherein:
in detecting the operation on the icon, the processor is further caused to detect a duration of the operation on the icon, when the operation on the icon has been detected; and
in acquiring the first fingerprint information while the operation is acting on the icon, the processor is further configured to acquire, by the fingerprint detection component, the first fingerprint information, while the operation continues to act on the icon after the duration of the operation on the icon reaches a first duration.

15. The device of claim 14, the processor is further configured to:
output predetermined information in response to determining that the duration of the operation on the icon ends before reaching the first duration, wherein the predetermined information comprises at least one of the following:
prompt information for prompting a user to input information for executing the function associated with the icon; or
a verification input interface for inputting verification information for executing the function associated with the icon.

16. The device of claim 11, the processor is further configured to:
present a fingerprint information input interface in response to determining that the first fingerprint information is not matched with the second fingerprint information.

17. The device of claim 11, wherein the processor is configured to perform one of:
instructing the display screen to display the icon in a predetermined full-screen display area of the display screen, wherein the fingerprint detection component is provided at the icon within the full-screen display area; or
acquiring a human-machine interaction signal from a user, and instructing the display screen to display the icon in a local area of the display screen based on the human-machine interaction signal, wherein the fingerprint detection component is provided at the icon at least in the local area of the display screen.

18. The device of claim 11, wherein the processor is configured to perform at least one of the following:
when the icon is an application icon of an application, starting the application;
when the icon is a file icon of a file, opening the file; or
when the icon is a control icon of a payment control, executing a payment operation.

19. The device of claim 11, wherein the processor is configured to:
detect a touch operation or a hovering operation on the icon.

20. (canceled)

21. The method of claim 1, wherein executing, by the terminal based on the duration of the operation on the icon, the function associated with the icon comprises:
in response to determining that the duration of the operation on the icon is greater than a preset duration threshold, executing a first function associated with the icon; or
in response to determining that the duration of the operation on the icon is no greater than the preset duration threshold, executing a second function associated with the icon, wherein the second function is different from the first function.

22. The device of claim 11, wherein:
in executing, based on the duration of the operation on the icon, the function associated with the icon, the processor is configured to:
in response to determining that the duration of the operation on the icon is greater than a preset duration threshold, execute a first function associated with the icon; or
in response to determining that the duration of the operation on the icon is no greater than the preset duration threshold, execute a second function associated with the icon, wherein the second function is different from the first function.
